(19) United States
(12) Patent Application Publication
(10) Pub. No.: US 2014/0225524 A1
(43) Pub. Date: Aug. 14, 2014

(54) HIGH EFFICIENCY LED DRIVER CIRCUIT

(71) Applicant: Masdar Institute of Science and Technology, Masdar City (AE)

(72) Inventors: Wala Saadeh, Masdar City (AE); Michael H. Perrott, Nashua, NH (US)

(73) Assignee: Masdar Institute of Science and Technology, Masdar City (AE)

(21) Appl. No.: 14/181,551

(22) Filed: Feb. 14, 2014

Related U.S. Application Data
(60) Provisional application No. 61/940,267, filed on Feb. 14, 2014.
(60) Provisional application No. 61/764,964, filed on Feb. 14, 2013.

(51) Int. Cl. H05B 33/08

(52) U.S. Cl. CPC H05B 33/0815
USPC 315/224

(57) ABSTRACT

A circuit arrangement for a Light Emitting Diode (LED) driver of an LED is an inductor-based boost circuit arrangement with an inductor, switch, and LED. Power stored inductively may be delivered to the LED in the form of current through use of switching. The switching may include a first switching phase and a second switching phase. The inductor-based boost circuit arrangement lowers cost and increases reliability as compared with existing LED drivers. Further, the circuit arrangement has improved efficiency compared with existing LED drivers.

### RELATED APPLICATION

This application claims the benefit of U.S. Provisional Application No. 61/764,964, filed on Feb. 14, 2013 and U.S. Provisional Application No. 61/940,267, filed on Feb. 14, 2014. The entire teachings of the above applications are incorporated herein by reference.

### BACKGROUND

A rectifier diode may be configured to enable electrical current to flow in only one direction and may be used for power supply operation. Rectifier diodes may handle higher current flow than regular diodes and are generally used in order to change alternating current into direct current. Rectifier diodes may be designed as discrete components or as integrated circuits and are usually fabricated from silicon. Rectifier diodes may be characterized by a fairly large P-N-junction surface that results in high capacitance under reverse-bias conditions. In high-voltage supplies, two rectifier diodes or more may be connected in series in order to increase the peak-inverse-voltage (PIV) rating of the combination.

### SUMMARY

Embodiments of the present invention provide a circuit arrangement and device for providing illumination.

According to one embodiment, a circuit arrangement may comprise an inductive path, a switch path, and an illumination path coupled to a common junction. Current flowing through the inductive path may (i) source current through the common junction to the switch path during a first state of a switching element of the switch path, and may (ii) source current through the common junction to the illumination path during a second state of the switching element.

The inductive path may include an inductor having an ingress lead and an egress lead. The ingress lead may be coupled to a voltage source and the egress lead may be coupled to the common junction.

The illumination path may include a Light Emitting Diode (LED) connected between the common junction and a reference potential.

The switching element may be a switch connected between the common junction and a reference potential. A gate of the switch may be controlled via an input clock with a controlled duty cycle.

The switching element may be a switch. The first state of the switching element may be an on state of the switch. The current may progressively increase according to a time duration of the on state of the switch.

The switching element may be a switch and the second state of the switching element may be an off state of the switch. The current may progressively decrease according to a time duration of the off state of the switch.

The illumination path may include an illumination element. The illumination element may be turned on based on a transition from the first state to the second state. Light emission from the illumination element may be inversely proportional to a time duration of the second state of the switch.

The inductive path may include an inductor, the switching path may include a switch, the illumination path may include an LED. The first state of the switching element may be an on state of the switch. The second state of the switching element may be an off state of the switch. Each cycle of turning the switch from the on state to the off state may deliver a current pulse through the LED. A maximum value of the current pulse may be set by a voltage level at an ingress lead of the inductor, an inductance value of the inductor, and a duration of the on state of the switch.

The illumination path may include an LED and no capacitive path may be coupled to the common junction.

A device may comprising a housing and the circuit arrangement.

The device may be one of a heart rate monitor, oximetry device, LED flashlight, or LED display.

Another example embodiment may include a method. The method may comprise inductively storing power. The method may comprise delivering the power stored inductively in the form of current through use of switching, the switching including a first switching phase and a second switching phase. The method may comprise producing illumination as a function of the current based on a transition from the first switching phase to the second switching phase. The illumination produced may decrease as a function of a time duration of the second switching phase.

Producing the illumination may include stimulating a Light Emitting Diode (LED) with the current.

The switching may include controlling a gate of a switch via an input clock with a controlled duty cycle to transition between the first and second switching phases.

The method may include progressively increasing the inductively stored power during the first switching phase according to a time duration of the first switching phase.

The method may include progressively decreasing the power stored inductively according to a time duration of the second phase.

Producing the illumination may include stimulating an LED with the current. Producing the illumination may include emitting light from the LED based on the transition from the first switching phase to the second switching phase.

Producing the illumination may include stimulating an LED with the current and inductively storing the power may include sourcing a current flow through an inductor. Each transition from the first switching phase to the second switching phase may include delivering a current pulse through the LED.

The method may include setting a maximum value of the current pulse by a voltage level at an ingress lead of the inductor, an inductance value of the inductor, and a duration of the first switching phase.

Another example of embodiments may include a circuit arrangement may comprise an inductive path, a switch path, and an illumination path. The inductive path, the switch path, and the illumination path may each include a single respective circuit element and may each be directly coupled to an egress lead of the inductive path.

The respective circuit element of the inductive path may be an inductor directly coupled to an ingress lead of the inductive path and the egress lead. The ingress lead of the inductive path may be directly coupled to a voltage source.

The respective circuit element of the illumination path may be a Light Emitting Diode (LED) directly coupled to the egress lead of the inductive path and a reference potential.

The respective circuit element of the switch path may be a switch, directly coupled to the egress lead of the inductive path and a reference potential, and a gate of the switch may be controlled via an input clock with a controlled duty cycle.

The respective circuit element of the switch path may be a switch, and current flowing through the inductive path in a direction from the ingress lead to the egress lead may be directed through the switch path based on an on state of the switch. The current may progressively increase according to a time duration of the on state of the switch.

The respective circuit element of the switch path may be a switch, and current flowing through the inductive path in a direction from the ingress lead to the egress lead may be re-directed from the switch path to flow through the illumination path based on an off state of the switch. The current may progressively decrease according to a time duration of the off state of the switch.

The respective circuit element of the illumination path may be an LED, and light emission from the LED may eventually stop based on the time duration of the off state of the switch.

The respective circuit element of the inductive path may be an inductor, the respective circuit element of the switch path may be a switch, and the respective circuit element of the illumination path may be an LED. Each cycle of turning the switch from an on state to an off state may deliver a current pulse through the LED. A maximum value of the current pulse may be set by a voltage level at an ingress lead of the inductive path, an inductance value of the inductor, and a duration of the on state of the switch.

The respective circuit element of the illumination path may be an LED, and no capacitive circuit element may be configured in parallel with the LED in the circuit arrangement.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of an example embodiment of an application of an LED and accompanying LED driver circuit for a portable heart rate monitor.

FIG. 2 is a high level block diagram of an example embodiment of a circuit arrangement for the LED driver of FIG. 1.

FIG. 3 is a flow diagram of an example embodiment of a method.

FIG. 4 is a block diagram of an example embodiment of a circuit arrangement for the LED driver of FIG. 1.

FIG. 5 is a block diagram of the example embodiment for the circuit arrangement of FIG. 4 for cases in which (a) the switch device is ON, and (b) the switch device is OFF.

FIG. 6 is a graph 600 of a typical LED efficiency characteristic for pulsed versus DC current into an LED.

FIG. 7 is a block diagram of an example embodiment of the circuit arrangement of FIG. 4 that leverages clock gating to control the average output current.

FIG. 8 is block diagram of graphs based on using pulse gating to control the average current through the LED with the circuit arrangement of FIG. 4 for the LED driver of FIG. 1.

FIG. 9 is block diagram of an example embodiment of FIG. 4 using gating of pulses to achieve a desired average output light intensity.

FIG. 10 is a block diagram of an example embodiment of FIG. 4 using a gate bootstrapping technique to increase the turn on voltage for the switch gate of the switch device.

FIG. 11 is a block diagram of an example embodiment of a pulse control using a simple frequency divider which enables reduction of the average light intensity by the factor 2⁻ⁿ, where n is an integer value with range zero to the number of divider stages.

FIG. 12 is a block diagram of graphs for LED output voltage and current with a duty cycle of 50% for the example embodiment of FIG. 11.

FIG. 13 is a graph of average LED current for different gating factors using the example embodiment for a simple frequency divider design shown in FIG. 11.

FIG. 14 is a graph of LED driver efficiency for different gating factors of FIG. 13 using the example embodiment for the simple frequency divider design shown in FIG. 11.

FIG. 15 is a graph of power efficiency versus supply voltage and CMOS switch device width for an example embodiment of a 180 nm CMOS design without gate bootstrapping.

FIG. 16 is a block diagram of a relationship between inductor size, switching frequency and LED driver efficiency.

FIG. 17 is a table of relative power levels of various parts of the example embodiment for the circuit arrangement for the LED driver for the example embodiment of the implementation of FIG. 11.

FIG. 18 is a block diagram of an example of the internal structure of a computer in which various embodiments disclosed herein may be implemented.

### DETAILED DESCRIPTION OF THE INVENTION

Embodiments disclosed herein may provide a highly efficient Light Emitting Diode (LED) driver circuit arrangement that may require fewer components than existing designs and may achieve improved power efficiency. The circuit arrangement may be especially advantageous when an available supply voltage is significantly lower than an LED turn on voltage, and when the LED turn on voltage is somewhat comparable to a turn on voltage of a rectifying diode. Embodiments disclosed herein may pulse LED current rather than provide a relatively constant value for the LED driver current, leading to improved efficiency with regard to emission characteristics of the LED for a case of low average LED currents.

Embodiments disclosed herein may be especially useful for portable applications which require operation of an LED with well controlled current in a power efficient manner. Such applications include portable heart rate monitors, oximetry devices, LED flashlights, LED displays, and other applications. LEDs offer a very efficient and robust light source for a wide variety of applications.

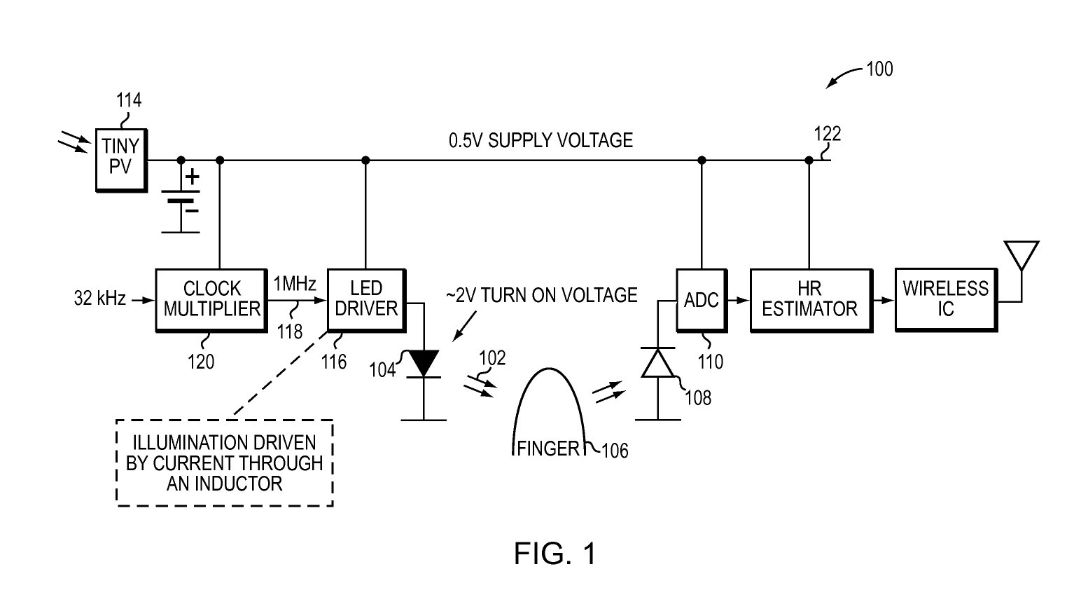

FIG. 1 is a block diagram 100 of an example embodiment of an application of an LED 104 and an accompanying LED driver circuit 116 for a portable heart rate monitor. As shown in FIG. 1, light 102 generated by the LED 104 is transmitted through a finger 106 or other tissue and then detected with a photo detector circuit comprising a photodiode 108 and an analog-to-digital converter (ADC) 110. In the example embodiment, a low supply voltage 122 is 0.5V, which may be advantageous for achieving low power consumption of integrated circuits used in the heart rate monitor. The low supply voltage 122 provides a convenient voltage for obtaining power directly from a photovoltaic (PV) cell 114.

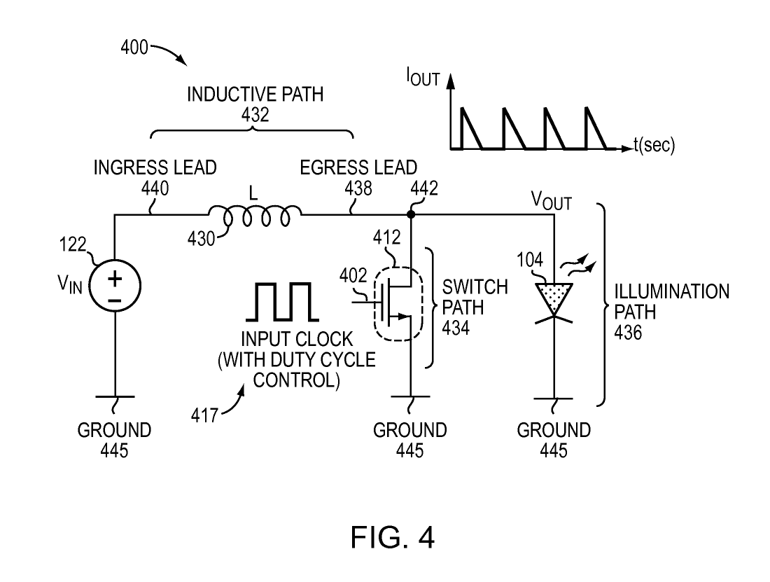

A challenge in powering the LED 104 is that the LED turn on voltage is often around 2V, which is significantly higher than the low supply voltage 122 that is 0.5V. As such, an LED driver circuit 116 may be operatively coupled to the LED 104 to boost the 0.5V supply voltage 122 efficiently to enable light emission 102 from the LED 104. The LED driver circuit may require an input clock 118, which may be 1 MHz in the heart rate monitor example embodiment of FIG. 1, but may be arbitrarily set with the aid of a clock multiplier circuit 120 as shown in FIG. 1. As disclosed below with reference to FIG. 4, the LED driver circuit 116 (also referred to herein as the LED driver 116) may be implemented based on an inductor-based boost converter circuit arrangement.

Design of the LED driver 116 presents challenges for achieving high efficiency when low supply and/or low output voltages are required since such low voltage often leads to high resistance during the turn on state of the switches and therefore leads to increased loss. A switched capacitor-based design approach may provide an additional challenge in that several stages may be required when striving for a voltage boost by a factor of four (i.e., 2V/0.5V) or more. Embodiments disclosed herein may be based on an inductor-based boost converter enabling a relatively large voltage boost factor with an simple and efficient design.

While utilizing a rectifying diode with a reduced turn on voltage may be an attractive approach, such devices are generally unavailable within standard fabrication processes. A complementary metal-oxide-semiconductor (CMOS) device may be used to reduce the turn on voltage of the rectifying diode; however, the CMOS device still creates loss due to its finite on resistance. As such, it is worthwhile to consider if there are better approaches to achieve a highly efficient LED driver circuit architecture that eliminates such issues.

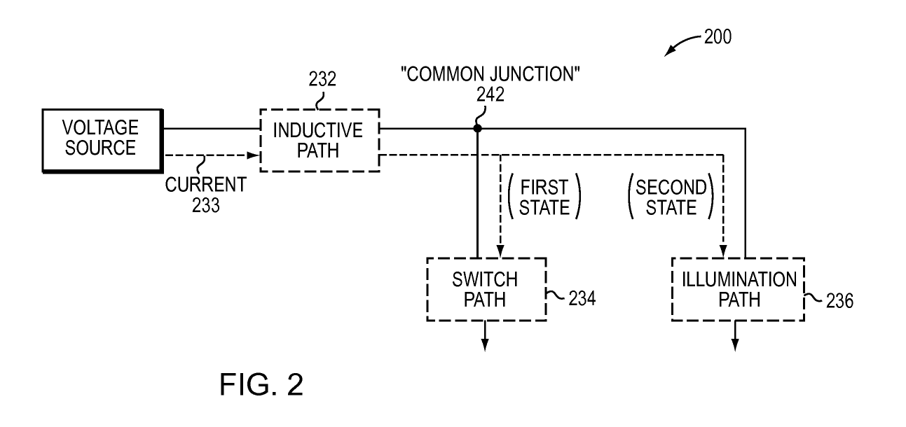

FIG. 2 is a high level block diagram of an example embodiment of current flow in a circuit arrangement 200 for the LED driver of FIG. 1. The circuit arrangement 400 may comprise an inductive path 232, a switch path 234, and an illumination path 236 coupled to a common junction 242. The inductive path 232 may include an inductor 230. The switch path 232 may include a switch 212. The illumination path 236 may include an illumination element 204, such as a Light Emitting Diode (LED) or other illumination element that is stimulated by current or voltage. Current 233 flowing through the inductive path 232 may source current flowing through the common junction 242 to the switch path 234 during a first state of the switching element 212 of the switch path 234. Current 233 flowing through the inductive path 232 may source current flowing through the common junction 242 to the illumination path 236 during a second state of the switching element 212.

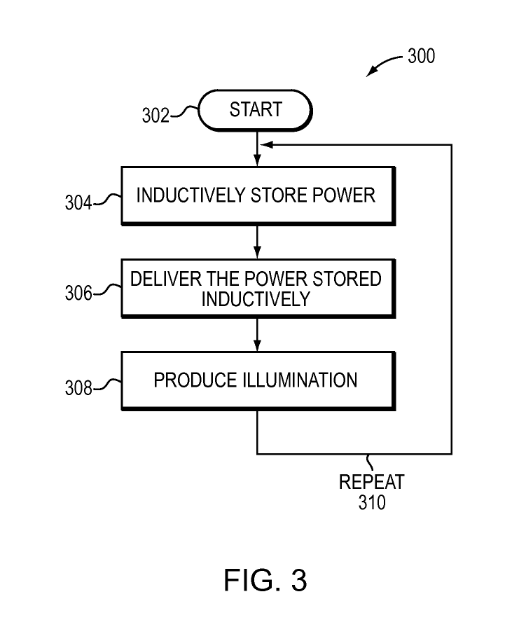

FIG. 3 is a flow diagram 300 of an example embodiment of a method. The method may begin (302) and inductively store power (304). The method may deliver the power stored inductively in the form of current through use of switching, the switching including a first switching phase and a second switching phase (306). The method produce illumination as a function of the current based on a transition from the first switching phase to the second switching phase, the illumination produced decreasing as a function of a time duration of the second switching phase (308), and the method repeats (310) in the example embodiment.

FIG. 4 is an example embodiment of a circuit arrangement 400 for the LED driver 116 of FIG. 1. As shown in FIG. 4, the circuit topology 400 for the LED driver 116 has few components. As such, the circuit topology 400 lowers cost and increases reliability in comparison with other approaches. Further, the circuit topology 400 of the example embodiment may be highly efficient since there is no loss due to a rectifying diode. As disclosed above, a rectifying diode presents a challenge because the turn on voltage of the rectifying diode may be a significant portion of the turn on voltage of the LED 104, resulting in substantial loss.

The circuit arrangement 400 may comprise an inductive path 432, a switch path 434, and an illumination path 436 coupled to a common junction 442. Current flowing through the inductive path 432 may source current through the common junction 442 to the switch path 434 during a first state of a switching element of the switch path 434, and may source current through the common junction 442 to the illumination path 436 during a second state of the switching element.

The inductive path 432 may include an inductor 430 having an ingress lead 440 and an egress lead 438. The ingress lead 440 may be coupled to a voltage source 122, and the egress lead 438 may be coupled to the common junction 442. The illumination path 436 may include a Light Emitting Diode (LED) 104 connected between the common junction 442 and a reference potential 445. The reference potential 445 may be any suitable reference potential, such as ground in the example embodiment.

The switching element may be a switch 412 connected between the common junction 442 and the reference potential 445. A gate 402 of the switch 412 may be controlled via an input clock 417 with a controlled duty cycle.

The LED 104 may be turned on based on a transition from an on state of the switch 412 to an off state of the switch 412. Light emission from the LED 104 may be may be inversely proportional to a time duration of the off state of the switch 412. Each cycle of turning the switch 412 from the on state to the off state may deliver a current pulse through the LED. A maximum value of the current pulse may be set by a voltage level at the ingress lead 440 of the inductor 430, an inductance value of the inductor 430, and a duration of the on state of the switch 412.

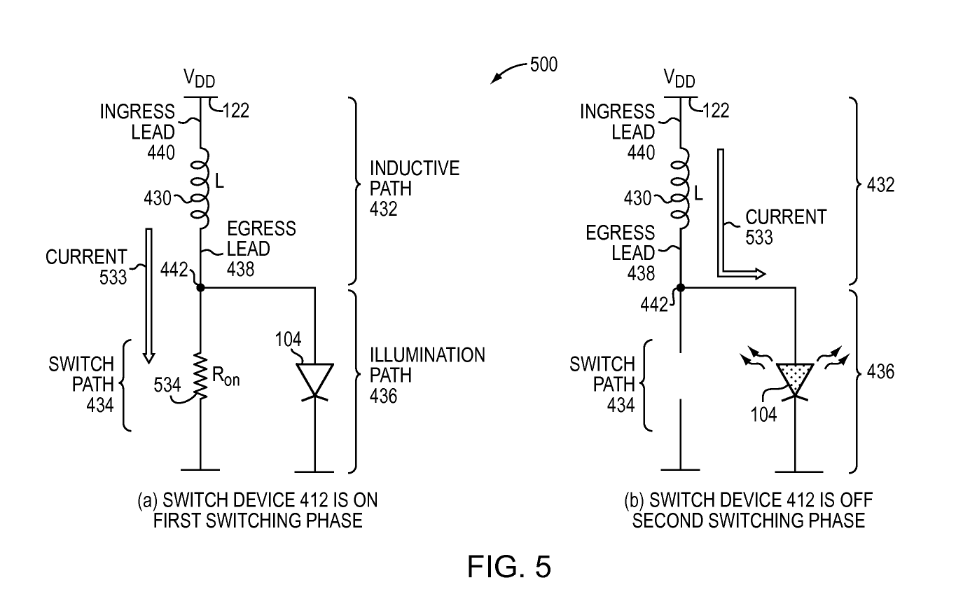

FIG. 5 is a block diagram 500 of the example embodiment for the circuit arrangement 400 of FIG. 4 for cases in which (a) the switch device 412 is ON, and (b) the switch device 412 is OFF. When the switch device 412 is ON, current 533 is directed through the switch device 412 such that the current 533 through the inductor 430 progressively increases according to the time duration that the switch is ON. The switch on-resistance, Rₒₙ 534, causes loss and should therefore be minimized through proper design of the switch device 412.

As such, current 533 flowing through the inductive path 432 in a direction from the ingress lead 440 to the egress lead 438 may be directed at the common junction 442 to flow through the switch path 434 based on an on state of the switch 412. The current 533 may progressively increase according to a time duration of the on state of the switch 412.

When the switch device 412 is turned OFF, the current 533 is redirected into the LED 104. This causes the voltage across the LED 104 to increase to its turn on voltage value immediately following the switch turn OFF event. The current 533 through the inductor 430 gradually decreases until eventually the LED 104 turns off. Each cycle of turning ON and OFF the switch device 412 therefore leads to a current pulse through the LED. The maximum value of the current pulse is set by the supply voltage 122, an inductance value of the inductor 430, and an ON time of the switch device 412. As such, current 533 flowing through the inductive path 432 in a direction from the ingress lead 440 to the egress lead 438 may be re-directed at the common junction 442 from the switch path 434 to flow through the illumination path 436 based on an off state of the switch 412. The current may progressively decrease according to a time duration of the off state of the switch 412.

As such, the example embodiment of FIG. 4 for the circuit arrangement of the LED driver 116 of FIG. 1 may draw improvements over other approaches by leveraging the following observations: the LED device acts as a rectifying element, higher power efficiency may be achieved since the major source of power loss is eliminated, and for relatively low average currents, the LED lighting efficiency is actually higher when pulsed than when a steady DC current flows through it since the LED is more efficient in emitting light at the higher current levels.

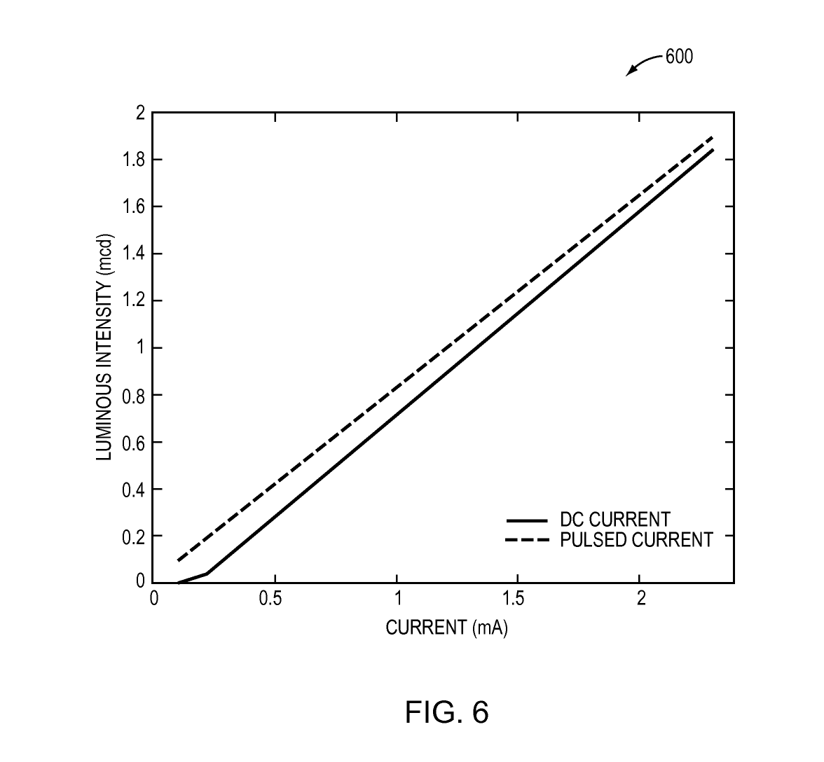

FIG. 6 is a graph 600 of a typical LED efficiency characteristic for pulsed versus DC current into an LED. The graph 600 shows that the LED device efficiency for pulsed versus DC current for 0.3 to 2.3 mA average LED current. For relatively low average currents, the graph 600 shows that the LED lighting efficiency is actually higher when pulsed than when a steady DC current flows through it. As such, the pulsing action improves the LED lighting efficiency by producing higher luminous intensity for a given average current, especially when the average current is relatively low (e.g., <3 mA).

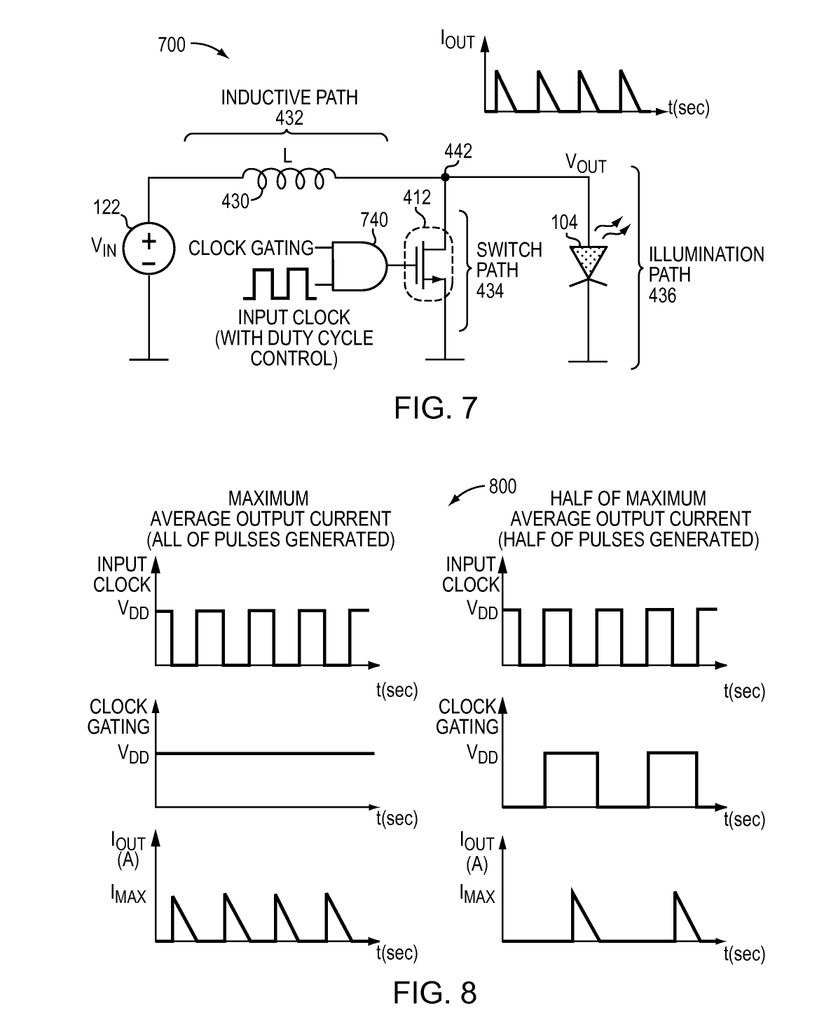

FIG. 7 is a block diagram 700 of an example embodiment of the circuit topology 400 of FIG. 4 that leverages clock gating to control the average output current. While the example embodiment of a modified boost converter 400 of FIG. 4 may utilize duty cycle control as a means to vary the average output current, its pulsed output characteristic also allows for a simple gating approach of the current pulsing in order to control the average output current. For example, FIG. 7 illustrates a simple implementation of achieving such clock gating by using an AND gate 740 to enable or disable clock pulses to the gate of the switch device 412.

FIG. 8 is block diagram 800 of graphs based on using pulse gating to control the average current through the LED 104 with the circuit topology 400 of FIG. 4 for the LED driver 116 of FIG. 1. FIG. 8 shows two examples of clock gating applied to the topology 700 of FIG. 7, where the left sided graphs correspond to achieving maximum average output current and the right sided graphs correspond to achieving half of the maximum average output current by gating only half of the clock pulses through to the gate of the switch device 412.

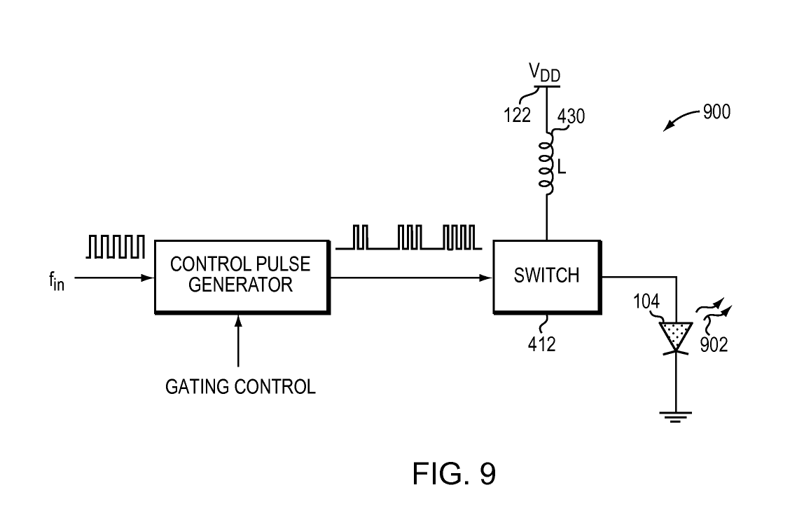

FIG. 9 is block diagram 900 of an example embodiment of FIG. 4 using gating of pulses to achieve a desired average output light intensity 902. Such a gating approach may be extended to achieve a wide range of average output current through more complicated pulse gating methods as indicated by FIG. 9. In general, such pulse gating techniques may be implemented with purely digital logic and may include the use of frequency dividers (not shown) and Sigma Delta modulators (not shown). Using a Sigma Delta modulator to control the pulse gating has the advantage of enabling very high resolution control of the average light intensity from the LED, but may consume more power than simpler techniques such as using a frequency divider.

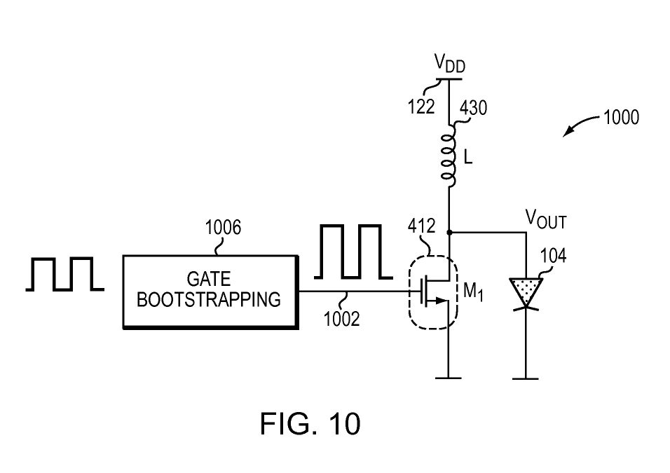

FIG. 10 is a block diagram 1000 of an example embodiment of FIG. 4 using a gate bootstrapping technique 1006 to increase the turn on voltage for the switch gate 1002 of the switch device 412. For very low supply voltages 122, applying the gate bootstrapping technique 1006 may be advantageous to reduce the on resistance, such as the Rₒₙ resistance 534 disclosed above with reference to FIG. 5, of the MOS device, such as the switch device 412, when it is switched ON. As shown in FIG. 10, gate bootstrapping 1006 increases the ON voltage on the gate 1002 of the switch device 412, which thereby lowers its resistance. Gate bootstrapping 1006 a common technique, and a number of implementation methods exist to achieve efficient operation.

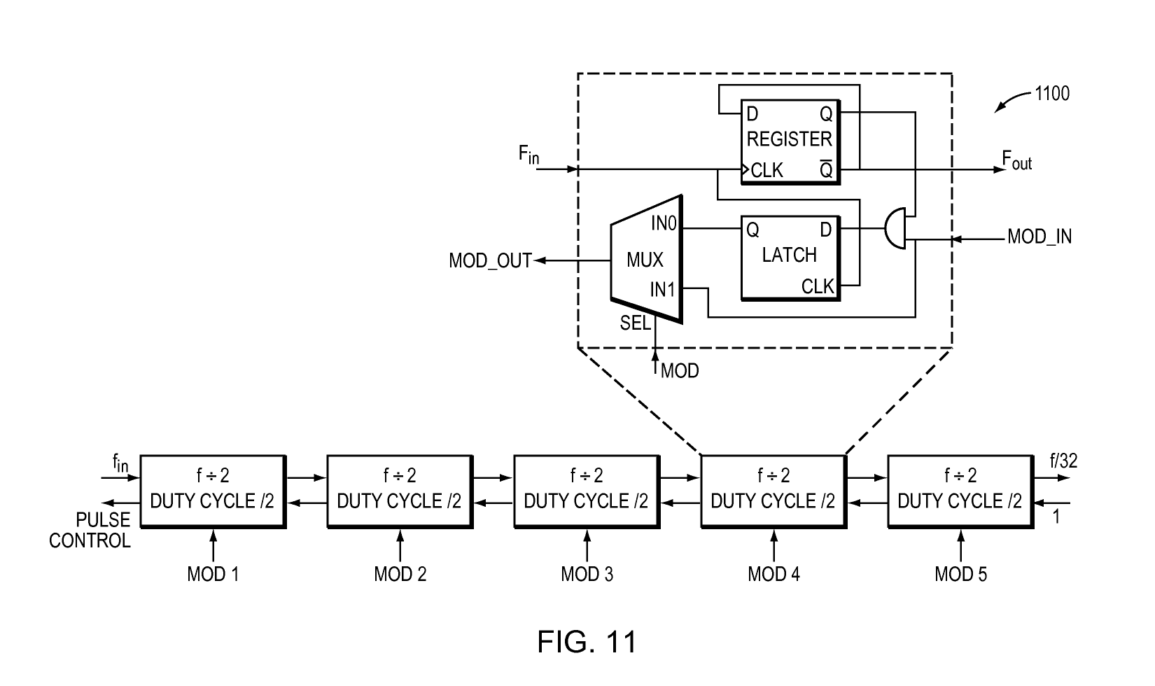

A custom integrated circuit has been developed to verify operation of the embodiment of the circuit topology 400 of FIG. 4 for the LED driver 116. A simple design was chosen that did not require the gate bootstrapping 1006 of FIG. 10, but did implement a pulse control circuit using a simple frequency divider to allow variable average output current using the gating method. The divider architecture is shown in FIG. 11, and allows for change in the LED light intensity by a factor of 2⁻ⁿ according to which Mod inputs are enabled.

FIG. 11 is a block diagram 1100 of an example embodiment of a pulse control using a simple frequency divider which enables reduction of the average light intensity by the factor 2⁻ⁿ, where n is an integer value with range zero to the number of divider stages.

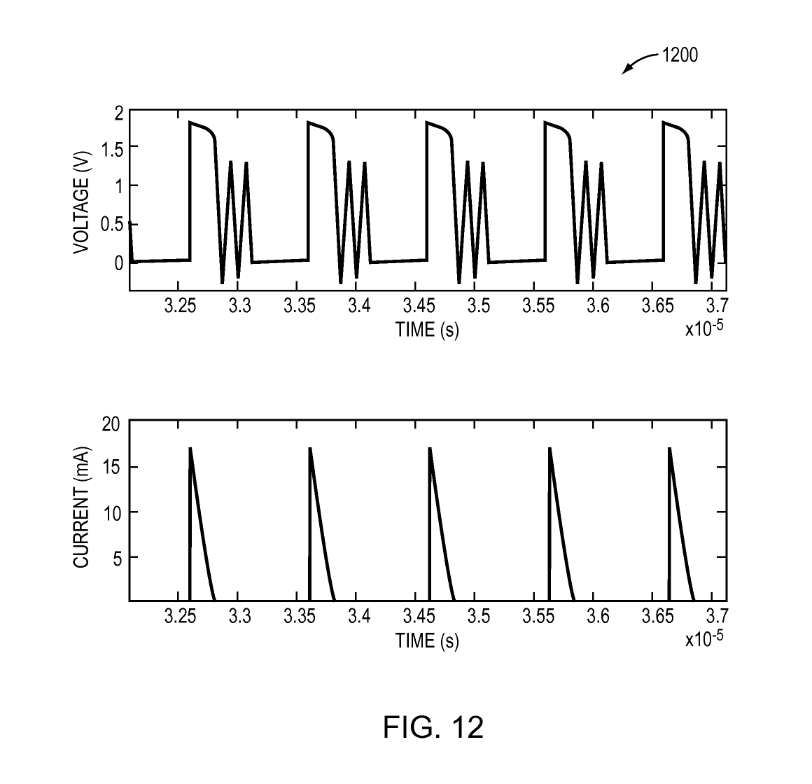

FIG. 12 is a block diagram 1200 of graphs for LED output voltage and current with a duty cycle of 50% for the example embodiment of FIG. 11. FIG. 12 shows simulated waveforms of voltage across the LED 104 and current through the LED 104 based on all pulses being gated through. When the switch device 412 is opened the LED 104 voltage immediately increases to about 1.8V such that the LED turns on as supplied by the inductor current. The LED current then reduces as the inductor energy is progressively consumed by the LED 104, until finally the current becomes small enough that the LED 104 turns off. Once the LED is off, the inductor 430 and parasitic capacitance of the LED 104 and other circuit elements causes oscillations to appear on the LED voltage. These oscillations continue until they are damped out by loss or by the switch turning on again.

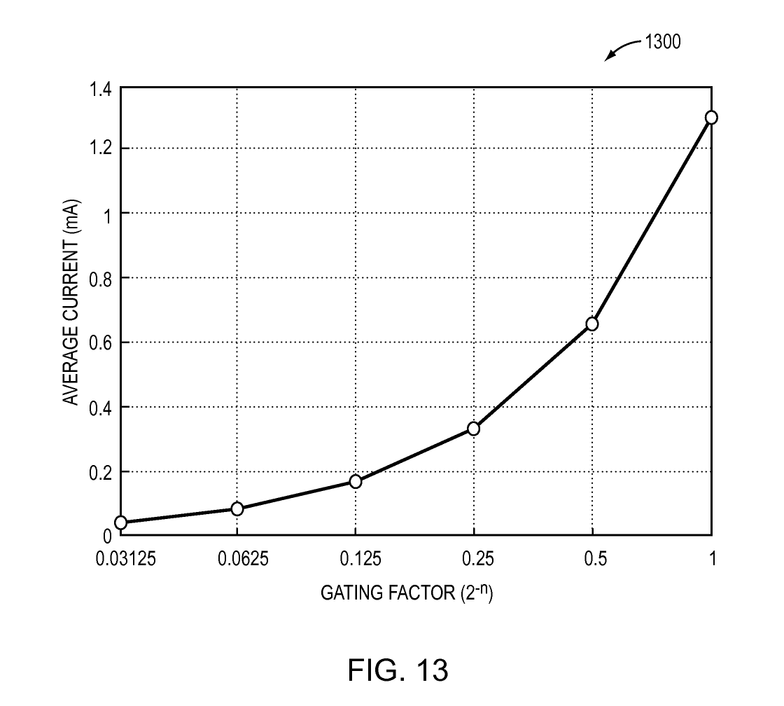

FIG. 13 is a graph 1300 of average LED current for different gating factors using the example embodiment for a simple frequency divider design shown in FIG. 11. The graph 1300 shows the simulated average LED current for different gating factors set by control of the frequency divider shown in FIG. 11. Each of the indicated points corresponds to a reduction in the average LED intensity by a factor of 2⁻ⁿ, where n is an integer ranging from zero to five (due to the fact that five divider stages were employed).

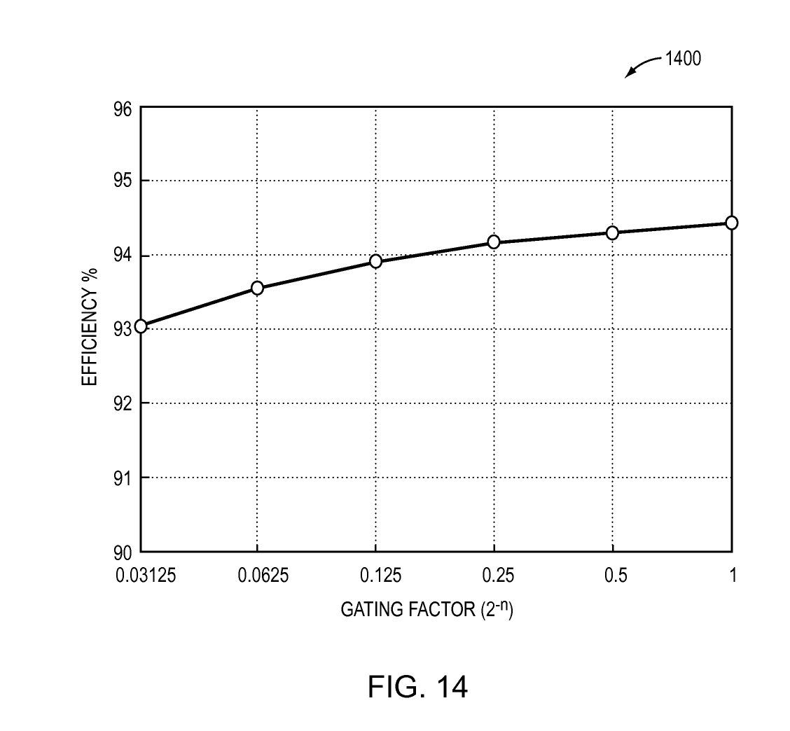

FIG. 14 is a graph 1400 of LED driver efficiency for different gating factors of FIG. 13 using the example embodiment for the simple frequency divider design shown in FIG. 11. For example, the graph 1400 shows the simulated LED driver power efficiency across the supported range of the gating factors of FIG. 13.

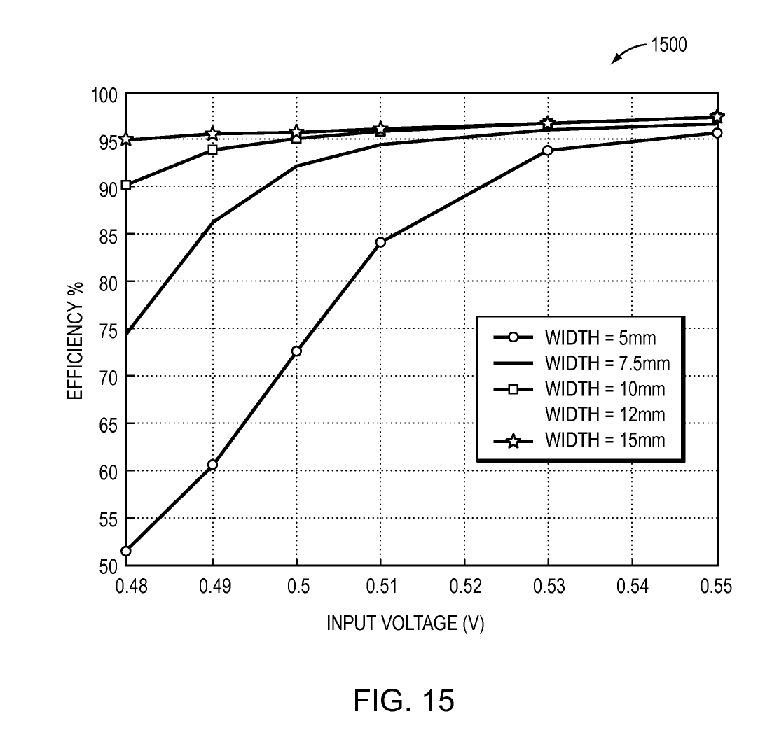

FIG. 15 is a graph 1500 of power efficiency versus supply voltage and CMOS switch device width for an example embodiment of a 180 nm CMOS design without gate bootstrapping. The graph 1500 shows the impact of supply voltage and the width of the CMOS switch device in achieving a given power efficiency for the LED driver. In the example embodiment, an improved efficiency for larger switch device widths is shown since the ON resistance of the switch is the dominant loss mechanism. Note that under the given supply voltage and switch width range considered in the example embodiment, switching loss caused by charging and discharging the gate of the switch device is less than the dominant loss caused by the switch ON resistance. However, higher supply voltages or the utilization of gate bootstrapping may cause the switching loss to become more significant and thereby introduce an upper limit on how large the switch device should be set for optimal efficiency.

Typically, a very high switching frequency is required to reduce the size of the inductor that will lead to an increase in the switching losses and thus causes a drop in the driver power efficiency. By lowering the switching frequency a larger inductor is needed but this large inductor tends to have higher series resistance which will also cause a drop in the efficiency.

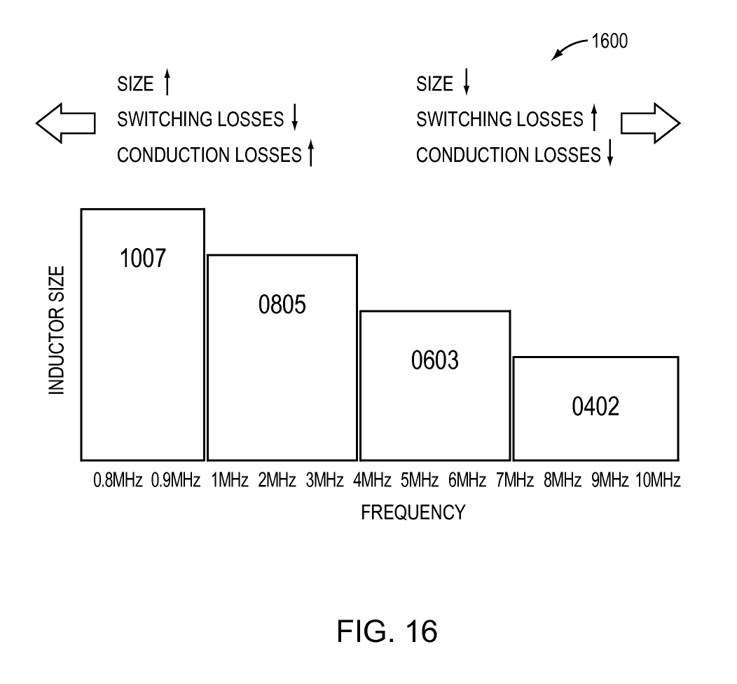

FIG. 16 is a block diagram 1600 of a relationship between inductor size, switching frequency and LED driver efficiency. FIG. 16 shows a tradeoff between inductor size, switching frequency and the LED driver efficiency. As shown in the block diagram 1600, in order to meet a desired high efficiency requirement of the LED driver at a switching frequency of 1 MHz, an optimal inductor value of 15 uH may be selected. This 15 H inductor may be provided in a 0805 package size from different vendors.

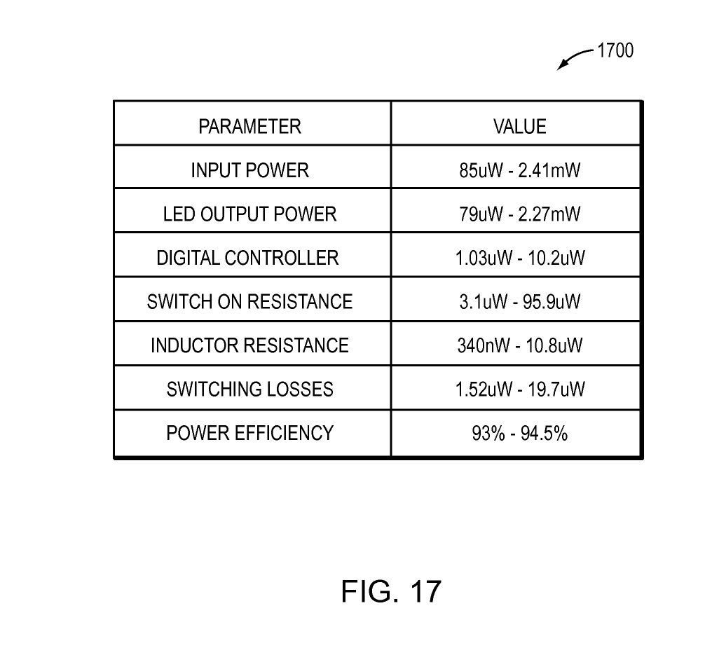

FIG. 17 is a table 1700 of relative power levels of various parts of the example embodiment for the circuit topology 400 for the LED driver 116 for the example embodiment of the implementation of FIG. 11. The power levels are estimates determined from simulation, and correspond to the cases where the gating control is set to minimize and maximize the light intensity of the LED 104 respectively. One should note in this implementation that the switch on resistance is indeed the largest loss mechanism, so that future designs should strongly consider the use of gate bootstrapping to lower this value as disclosed herein.

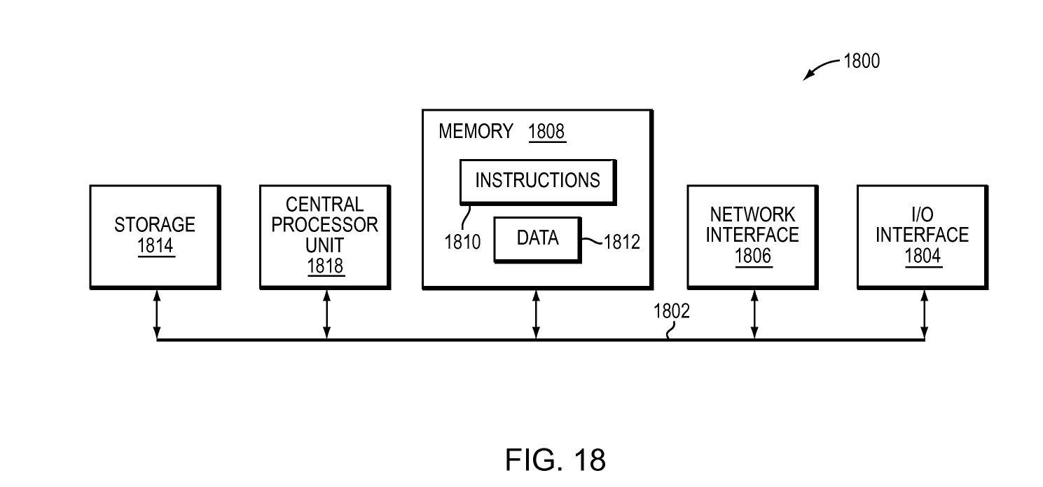

FIG. 18 is a block diagram of an example of the internal structure of a computer 1800 in which various embodiments disclosed herein may be implemented. A central processor unit 1818 is operative with a system bus 1802 and provides for execution of computer instructions that may, for example, configure the clock multiplier 120 of FIG. 1 to produce control signaling to the gate 402 of the switch 412 as disclosed above with reference to FIG. 4. The computer 1800 contains the system bus 1802, where a bus is a set of hardware lines used for data transfer among the components of a computer or processing system. The system bus 1802 is essentially a shared conduit that connects different elements of a computer system (e.g., processor, disk storage, memory, input/output ports, network ports, etc.) that enables the transfer of information between the elements. Operative with the system bus 1802 is an I/O device interface 1804 for connecting various input and output devices (e.g., keyboard, mouse, displays, printers, speakers, etc.) to the computer 1800. A network interface 1806 allows the computer 1800 to connect to various other devices attached to a network. Memory 1808 provides volatile storage for computer software instructions 1810 and data 1812 that may be used to implement embodiments disclosed herein, such as control signaling to the gate 402 of the switch 412 as disclosed above with reference to FIG. 4. Disk storage 1814 provides non-volatile storage for computer software instructions 1810 and data 1812 that may be used to implement embodiments disclosed herein.

Further example embodiments disclosed herein may be configured using a computer program product; for example, controls may be programmed in software for implementing example embodiments disclosed herein, such as control signaling to the gate 402 of the switch 412 as disclosed above with reference to FIG. 4. Further, example embodiments disclosed herein may include a non-transitory computer-readable medium, associated with a processor producing the control signaling, containing instructions that may be executed by a processor, and, when executed, cause the processor to complete methods described herein. It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware.

It should be understood that the term “herein” is transferrable to an application or patent incorporating the teachings presented herein such that the subject matter, definitions, or data carries forward into the application or patent making the incorporation.

While this invention has been particularly shown and described with references to example embodiments thereof, it will be understood by those skilled in the art that various changes in form and details may be made therein without departing from the scope of the invention encompassed by the appended claims.

What is claimed is:

1. A circuit arrangement comprising:
an inductive path, a switch path, and an illumination path coupled to a common junction; and
wherein current flowing through the inductive path (i) sources current through the common junction to the switch path during a first state of a switching element of the switch path and (ii) sources current through the common junction to the illumination path during a second state of the switching element.

2. The circuit arrangement of claim 1, wherein the inductive path includes an inductor having an ingress lead and an egress lead and further wherein the ingress lead is coupled to a voltage source and the egress lead is coupled to the common junction.

3. The circuit arrangement of claim 2, wherein the illumination path includes a Light Emitting Diode (LED) connected between the common junction and a reference potential.

4. The circuit arrangement of claim 1, wherein the switching element is a switch connected between the common junction and a reference potential, and wherein a gate of the switch is controlled via an input clock with a controlled duty cycle.

5. The circuit arrangement of claim 1, wherein the switching element is a switch and further wherein the first state of the switching element is an on state of the switch and still further wherein the current progressively increases according to a time duration of the on state of the switch.

6. The circuit arrangement of claim 1, wherein the switching element is a switch and further wherein the second state of the switching element is an off state of the switch and still further wherein the current progressively decreases according to a time duration of the off state of the switch.

7. The circuit arrangement of claim 1, wherein the illumination path includes an illumination element and further wherein the illumination element is turned on based on a transition from the first state to the second state and still further wherein light emission from the illumination element is inversely proportional to a time duration of the second state of the switch.

8. The circuit arrangement of claim 1, wherein:
the inductive path includes an inductor;
the switching path includes a switch;
the illumination path includes an LED;
the first state of the switching element is an on state of the switch;
the second state of the switching element is an off state of the switch; and
further wherein each cycle of turning the switch from the on state to the off state delivers a current pulse through the LED, and still further wherein a maximum value of the current pulse is set by a voltage level at an ingress lead of the inductor, an inductance value of the inductor, and a duration of the on state of the switch.

9. The circuit arrangement of claim 1, wherein the illumination path includes an LED and further wherein no capacitive path is coupled to the common junction.

10. A device comprising a housing and the circuit arrangement of claim 1.

11. The device of claim 10, wherein the device is one of a heart rate monitor, oximetry device, LED flashlight, or LED display.

12. A method comprising:
inductively storing power;
delivering the power stored inductively in the form of current through use of switching, the switching including a first switching phase and a second switching phase; and
producing illumination as a function of the current based on a transition from the first switching phase to the second switching phase, the illumination produced decreasing as a function of a time duration of the second switching phase.

13. The method of claim 12, wherein producing the illumination includes stimulating a Light Emitting Diode (LED) with the current.

14. The method of claim 12, wherein the switching includes controlling a gate of a switch via an input clock with a controlled duty cycle to transition between the first and second switching phases.

15. The method of claim 12, further including progressively increasing the inductively stored power during the first switching phase according to a time duration of the first switching phase.

16. The method of claim 12, further including progressively decreasing the power stored inductively according to a time duration of the second phase.

17. The circuit arrangement of claim 12, wherein producing the illumination includes stimulating an LED with the current and wherein producing the illumination includes emitting light from the LED based on the transition from the first switching phase to the second switching phase.

18. The method of claim 12, wherein producing the illumination includes stimulating an LED with the current and wherein inductively storing the power includes sourcing a current flow through an inductor, and further wherein each transition from the first switching phase to the second switching phase includes delivering a current pulse through the LED.

19. The method of claim 18, further including setting a maximum value of the current pulse by a voltage level at an ingress lead of the inductor, an inductance value of the inductor, and a duration of the first switching phase.

20. An apparatus comprising:
means for inductively storing power;
means for delivering the power stored inductively in the form of current through use of switching, the switching including a first switching phase and a second switching phase; and
means for producing illumination as a function of the current based on a transition from the first switching phase to the second switching phase, the illumination produced decreasing as a function of a time duration of the second switching phase.
